(19) United States
(12) Patent Application Publication
(10) Pub. No.: US 2023/0280046 A1
(43) Pub. Date: Sep. 7, 2023

(54) AN ENERGY SYSTEM FOR SUPPLY OF HOT WATER

(71) Applicant: ACTIONZERO ESCOPOD LIMITED, Cork (IE)

(72) Inventors: Liam FLYNN, County Cork (IE); John O'LEARY, County Kerry (IE)

(73) Assignee: ACTIONZERO ESCOPOD LIMITED, Cork (IE)

(21) Appl. No.: 18/017,946

(22) PCT Filed: Jul. 16, 2021
(86) PCT No.: PCT/EP2021/070021

§ 371 Date: Jan. 25, 2023

(30) Foreign Application Priority Data
Jul. 28, 2020 (EP) 20188179.4

(51) Int. Cl. F24D 11/02; F24D 17/02; F24D 19/10

(52) U.S. Cl. CPC F24D 11/0228; F24D 11/0235; F24D 17/02; F24D 19/1039; F24D 2200/12; F24D 2220/0207; F24D 2200/18

(57) ABSTRACT

An energy system includes a turbine flue heat exchanger feeding a storage tank arranged to deliver water on a high temperature (90° C.) line to supply circuits. A heat pump and storage tank are arranged to deliver lower temperature (45° C.) water on a low temperature line to the supply circuits. A number of the supply circuits are each arranged to receive high temperature water, receive low temperature water, and use these flows to deliver a process water supply at a desired high, low or intermediate temperature (65° C.). In some each supply circuits the blending is controlled by control of a low temperature line pump according to temperature of the process outlet. The low temperature tank is supplied by a heat pump the inlet of which is fed by a heat recovery heat exchanger which recovers waste heat from a plant, and so it is more efficient than if it received cold water. Electrical energy for the heat pump is at least partly supplied by the high temperature heater gas turbine. Overall, the system has excellent energy efficiency due to the manner in which waste heat is utilized, improved efficiency of a heat pump, and real time control of the high and low water lines.

### INTRODUCTION

The invention relates to an energy system for premises which require substantial volumes of water heated, possibly to a variety of temperatures, and possible also electrical power, and which may also require refrigeration, cooling or chilling.

Heating water can be done through a variety of means. Boilers are an energy conversion technology with Co-efficient of Performance (“COP”) of always less than 1. As fuel costs increase, the cost of heating increases proportionately.

Vapour compression heat pumps are a heat transfer technology with a COP of typically greater than 1, which degrades with increasing compression ratio. The compression ratio, and therefore efficiency, is adversely affected by reducing source temperature, and by increasing water leaving temperature requirement. They are more efficient at lower compression ratios.

CHP (“combined heat and power”, and otherwise known as “cogeneration” systems) have a COP of less than 1 and require a “spark gap” of a certain magnitude to realise cost-efficiency. As the spark gap narrows, the CHP becomes less cost efficient.

Trigeneration is a variant of cogeneration, in which the heat output of cogeneration is used to drive an absorption chilling system that delivers chilling as an output. One of the outputs of the cogeneration component is therefore consumed or part consumed to deliver the third output, via a chiller with a COP of less than 1.

An objective of the invention is to improve efficiency in provision of hot water for environments such as a food processing factory, linen washing plant, hospital, hotel, pharma, or similar users of hot water.

### SUMMARY OF THE DISCLOSURE

The invention provides an energy system as set out in claim 1, and other aspects are described in claims 2 to 15. The invention also provides a method of operation of an energy system as set out in claim 16, and other aspects of the method are set out in claims 17 to 26.

We describe an energy system comprising components including a controller and:
a high temperature water heater and storage tank arranged to deliver hot water on a high temperature line,
a heat pump and storage tank arranged to deliver lower temperature water on a low temperature line, and
a plurality of hot water supply circuits each arranged to receive water for one or both of the lines to provide a process water supply.

Preferably, the supply circuits receive high temperature water from the high temperature line, receive low temperature water from the low temperature line, and deliver a process water supply at a desired high, low, or intermediate temperature in an outlet line, in which a supply circuit delivering water at an intermediate temperature is arranged to blend the high temperature and low temperature flows. Preferably, at least one supply circuit comprises a return.

Preferably, the system comprises a pump for delivering high temperature water to the supply circuits, and the controller is configured to control said pump according to sensed pressure between the pump and the supply circuits. Preferably, the controller is configured to control the water heater and the blending in real time.

Preferably, at least one supply circuit comprises a low temperature line pump, and the controller is configured to control said pump according to sensed temperature in the supply circuit outlet line to achieve a desired level of blending. Preferably, at least one supply circuit receives water only from the high temperature line.

Preferably, said at least one supply circuit comprises a temperature sensor in its outlet, and the controller is configured to control the high temperature water heater according to temperature sensed by said circuit.

Preferably, at least one supply circuit is arranged to deliver process water at the temperature of the low temperature line, and the controller controls a pump to dynamically control blending of water from the high temperature line, the low temperature line and a return line to provide process water.

Preferably, the high temperature water heater comprises a gas turbine and a flue gas heat exchanger, said heat exchanger being arranged to heat water for delivery to the high temperature storage tank. Preferably, the turbine is arranged to provide electrical energy for the heat pump, either directly or indirectly, with surplus generated electricity being provided for a process.

Preferably, the system comprises a heat recovery heat exchanger arranged to recover heat from external process equipment such as refrigeration equipment.

Preferably, the heat recovery heat exchanger is arranged to heat a cold water supply to a warm level provided to the heat pump, so that the heat pump can operate at a lower compression ratio than if it received the cold water supply Preferably, the heat pump is arranged to feed back water to the heat recovery heat exchanger inlet. Preferably, a set controlled output temperature from the heat pump is adjustable downwards to increase coefficient of performance COP of the heat pump.

### DETAILED DESCRIPTION OF THE INVENTION

The invention will be more clearly understood from the following description of some embodiments thereof, given by way of example only with reference to the accompanying drawings in which:

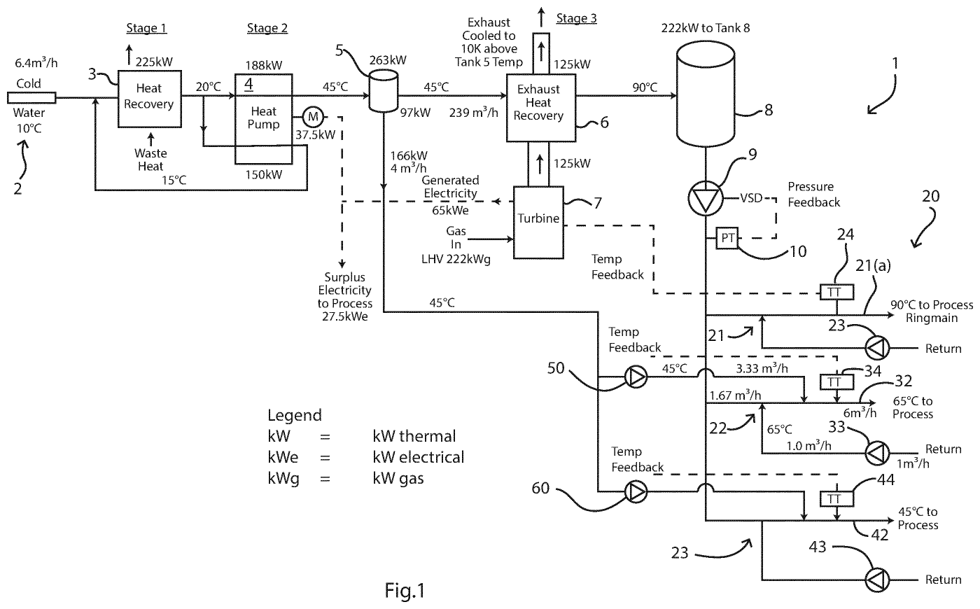

FIG. 1 is plant diagram illustrating an energy system of the invention; and

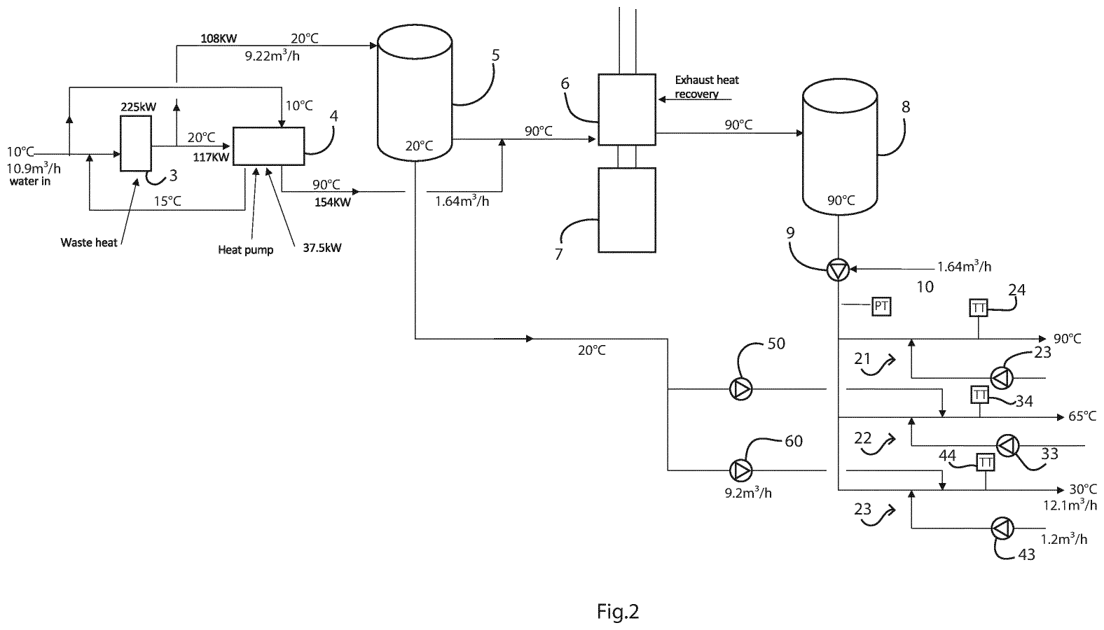

FIG. 2 is a diagram showing the plant with parameter values indicated for an alternative method of use.

We describe an energy system which supplies water at different temperature levels for various purposes. A major example of application of the system is a food processing plant with different load circuits each for a different purpose such as washing and process water. The system in some examples the system also supplies electrical power. It provides these supplies in a real time manner on-demand in a manner which minimises energy input and hence minimises CO₂ generated. The system is controlled by a digital controller linked as is known in the art for process automation. Links from the controller are either wired or wireless.

Referring to FIG. 1 an energy system 1 has a hot water tank 8 which holds water at a high temperature, say 90° C., in some cases with a margin above to allow for small losses. The energy for this comes from a third stage, Stage 3, which includes an exhaust heat exchanger 6 of a gas turbine 7, the output of which also generates electrical energy for a heat pump 4 of a second stage, Stage 2. The water from the high temperature tank 8 is fed on a high temperature line with a pump 9 to a set of supply circuits 20. A first stage, Stage 1, recovers waste heat from equipment to elevate temperature of a cold water supply for the heat pump of Stage 2, thereby significantly improving efficiency of the heat pump 6.

In more detail, the energy system 1 heats ambient temperature water to a high temperature, say 90° C., in various stages with each stage contributing to a given temperature rise. Stage 1 comprises a heat recovery heat exchanger (“HX”) 3 that heats ambient water for process use to say 20° C., using freely available waste heat. This process stream is further heated in additional stages. This HX 3 may have a second function, to contribute an additional water stream at 20° C. to act as a source for Stage 2, when Stage 2 comprises a water source heat pump 4. The efficiency of Stage 2 is elevated because of receiving a warmer source than ambient. Once source heat is extracted from this water stream, it is recirculated to the heat recovery HX 3 for reheating. Stage 2 may also use as its source a chilling circuit, or cooling tower circuit, or other waste water source, or it may be an air source heat pump, or a refrigeration compressor. The process component flows onward to the heat sink, or condenser, of the heat pump 4 used as Stage 2 heating, to elevate the temperature of the process water stream to say, 45° C., and is conveyed to a low temperature tank 5. Some of this 45° C. water may be used directly in the process and the remainder is used as the low temperature component for blending in the supply circuits 20.

A controlled output temperature from the heat pump 4 is preferably adjustable downwards to increase coefficient of performance (“COP”) of the heat pump.

Stage 3 receives the 45° C. water from the tank 5 and includes the turbine flue HX 6 which elevates the process flow to 90° C. and feeds a high temperature storage tank 8 arranged to deliver water on a high temperature (90° C.) line 9 to the supply circuits 20. The low temperature (LT) storage tank 5 may be arranged to deliver lower temperature (45° C.) water on a LT line 50, 60 to the supply circuits 20. A number of the supply circuits 20 are each arranged to receive high temperature (“HT”) water, receive LT water, and blend these flows to deliver a process water supply at a desired high, low or intermediate temperature (65° C.) in an outlet line 21(a), 32, 42.

A high temperature circuit 21 receives water directly from the HT line 9, and the temperature may be diluted by the cooling effect of a return pump 23, which will have a relatively small effect. The outlet temperature from flue HX 6 may be controlled and increased to compensate for this cooling effect to ensure that the required flow temperature is met. This control is achieved by feedback from a temperature sensor 24, resulting in the controller controlling the turbine 7 accordingly as indicated by the interrupted line from 24 to 7.

In each supply circuit where the required water temperature is lower than the HT supply temperature, the blending may for example be controlled by control of blending pumps 50, 60 according to temperature of the process outlet (32, 42).

The number and capacity of turbines selected determines the base heating capacity. For example, one turbine may heat 0.66 kg/s of water from 45° C. to 90° C. This same flow rate is heated upstream, from 10° C. to 20° C. (Stage 1), and 20° C. to 45° C. (Stage 2), as described in more detail below, with the capacity of Stages 1 and 2 being increased in proportion with the increased capacity of Stage 3. Other particular process factors may allow the proportional increase to be varied. The capacity of Stages 1 and 2 will also include the additional heating requirements of the 45° C. flow to blending and/or direct to process.

The water supply 2 is either direct from mains or a holding tank, and its temperature is typically about 10° C. This cold supply water is delivered to the heat recovery HX 3 which recovers heat from various refrigeration and air conditioning systems in the plant in which the system 1 is installed. So, its primary energy input is waste heat. The Stage 1 HX 3 comprises a plate heat exchanger, or other heat exchanger appropriate to the waste heat stream, with pump and control valves.

As an example, the flow rate of supply water to the heat recovery HX 3 may be 6.4 m³/hr. The HX 3 is rated at 225 kW, of which 75 kW is pre-heat energy to the received water, raising its temperature to about 20° C., and the remaining 150 kW is used to deliver source heat to the Stage 2 heat pump 4.

In an example, water is heated from 10° C. to 20° C., using low grade heat recovered in the HX 3 from the relevant industrial process, and this pre-heats additional water that is used as a source for the heat pump 4. The heat pump may alternatively be an air source heat pump, or it may use cooling tower water from an external chiller system, or use the chilling duty itself, as source.

The output water of the heat recovery HX 3, elevated to 20° C., is fed to the heat pump 4. This adds 188 kW of energy to the water, bringing its temperature up to 45° C., meaning that energy of 263 kW is delivered to the LT water tank 5.

A scaling factor applied to the heat pump 4 allows additional 45° C. water to be produced for direct use in the process, and for blending with 90° C. to produce, for example, wash water at a desired intermediate temperature.

In this example there are three process supply circuits 21, 22 and 23, each of which receives an input from the high temperature tank 8 via the pump 9. This pump is controlled according to pressure at its outlet to the blending circuits 20. The system controller therefore controls the delivery flow rate of HT water in real time according to overall demand in the supply circuits 20, which deliver water to the plant at the desired temperature and flow rates. Each circuit 21, 22, and 23 is for a particular process water system such as hand washing, plant washing, or meat treatment, and may be a ring main system with water constantly flowing in the circuit to ensure that temperature stagnation at periods of low use does not occur. Return pumps 23, 33, 43 are employed to effect this.

The circuit 21 has an outlet line 21(a), a temperature sensor 34, a return line 23 with a return pump. The temperature of the outlet line 22 is controlled as the output temperature of the Stage 3 heating system, being the turbine 7, and the heat exchanger 6.

The circuit 22 has an outlet 32, return pump 33, a temperature sensor 34, and a blending pump 50 controlled according to temperature feedback from a temperature sensor 34. The circuit 23 has an outlet 42, a return pump 43, a temperature sensor 44, and a blending pump 60 controlled according to temperature feedback from the sensor 44.

In this example the circuits 21, 22, and 23 provide water at 90° C., 65° C., and 45° C. respectively. However, these values may be varied by control of the pumps, 50, 60, and the outlet temperature of Stage 3. Also, the components feeding the tank 8 are controlled according to the highest desired temperature from the supply circuits. In this case the highest level is 90° C., and accordingly the HX 6 is controlled in real time to deliver water at the required elevated temperature so that the circuit 22 can maintain the water at a consistent level of 90° C. as measured by the sensor 24. This is to overcome the slight cooling effect of the return flow 23.

Returning to the energy flows, the turbine 7 exhaust flue provides 125 kW, which is added to the 45° C. water in order to deliver the 90° C. to the tank 8. The turbine 7 receives 222 kWg of energy from the gas, delivering 125 kW to the heat exchanger 6 and 65 kW in electrical power to the heat pump 4. In this example this electrical power is split into 37.5 kW to the heat pump and 27.5 kW to the process.

Overall, the primary energy inputs are the gas supply to the turbine 7 and the waste heat into the heat recovery HX 3. The system 1 captures low grade heat from the plant and uses this free energy to raise the temperature into the heat pump 4, thereby reducing its compression ratio. This initially-heated water may also be used to provide water to a process which uses water at this relatively low temperature. Hence the tank 5 is filled in an inexpensive way and which contributes little carbon dioxide generation. This tank directly supplies the blending, process water, circuits 20 via variable speed drive (VSD) pumps 50 and 60. This water may be used directly as in the circuit 23, or as a blending input as for the circuit 22. There is therefore optimum use of energy, with very little waste due to the real time control of the components to optimise the temperature in the tank 8 (according only to the maximum required at the circuit 21.

The following is an example energy profile.

| | Energy Inputs (kW) | | |
|---|---|---|---|
| | Waste heat :- | | |
| | Pre-heat | 75 | |
| | Source | 150 | |
| | | | 225 |
| | Gas | | 222 |
| | | | 447 |
| | Energy Outputs (kW) | | |
| | Heat | | |
| Stage 1 | Pre-heat | 75 | |
| Stage 2 | Heat Pump | 188 | |
| Stage 3 | Turbine | 125 | |
| | | | 388 |
| | Electricity (net) | | 27 |
| | | | 415 |
| | Losses (kW) | | 32 |

COP (Purchased (Imported) Energy Input/Useful Energy output)=222/415=1.87

CO₂ savings may be calculated as follows:

Grid electricity replaced: (27.5kWe/45.2)×100=60.8 kW

Thermal

Boiler at 80% nominal efficiency:

(388 kW/80)×100=485 kW

Sum=545.8 kW

There is a gas fuel input to the system 1 of 222 kW, replacing a prime energy input of 545.8 kW, yielding a saving of 323.8 kW of prime energy. Assuming a natural gas fuelled boiler, this equates to a saving of about 66.28 kg/hr CO₂.

Overall, the system 1 has excellent energy efficiency due to the manner in which waste heat is utilized, being recovered to preheat process water and also to elevate temperature of a cold water supply to optimize efficiency of a heat pump, which in turn feeds the low temperature storage tank used by the supply circuits for blending, and to preheat the process flow to the Flue heat exchanger 6.

Alternative Methods of Operation (FIG. 2)

The system may be operated using only the heat pump 4 to provide the high temperature water, bypassing the turbine 6 and using electricity from the grid to operate the heat pump. Such grid power is preferably from carbon-neutral sources such as wind power. This is shown in FIG. 2. In this example the heat pump 4 provides a flow of water at 90° C. and the low temperature tank 5 is fed directly from the Stage 1 heat exchanger 3, at about 20° C. in this example.

The water blending increases overall operating system efficiency by recovering energy from the heat pump and advantageous use of waste heat. This is achieved by supplying the lowest temperature water, about 10° C., to recover the condensing and subcooling energy from the heat pump to maximize its COP. The higher the supply temperature process water to be heated by the heat pump the lower the COP, as less subcooling can be recovered.

Heat recovery is used as a heat source for the heat pump 4 and the low temperature tank 5. For the heat pump 4 there is 10° C. in and 90° C. out which by-passes the tank 5 and fills the high temperature tank 8 with a piping configuration. This low-grade waste heat which can be 20° C. or more is injected to the blending circuits 22 and 23 by the blending system pumps 50 and 60 controlled by TT-34 and TT-44. The pump 9 operates at a reduced speed controlled by PT 10, and less energy will be required from the tank 8. When operating in this mode maximum kW energy and efficiency is delivered from the heat pump 4 and the waste heat HX 3. The blending can utilise waste heat at temperature above 10° C. which would in other prior systems be dumped to atmosphere.

Operating in this mode the invention overall COP is increased, and there is no burning of fossil fuels if the grip-provided power is by wind source.

### Example Scenarios

Heat recovery Stage 1 225 KW: 108 kW to tank 5 water in 10° C., water out 20° C., flow 9.281 litres/hr (L/h).

117 kW source to heat pump 37.5 kWe required

Heat pump output 117 kW+35.5 kW=150 kW, water in 10° C., water out 90° C., flow 1648 litres.

New flow rate 10.929 L/h

Energy delivered: 108 KW-150 KW=258 KW, operating power 37.5 KW

Overall COP 6.88.

Heat recovery Stage 1 225 KW 50 kW to tank 5, water in 10° C., water out 20° C., flow 4.296 L/h, 117 kW source to heat pump, 37.5 kWe required.

Heat pump output 117 kW+35.5 kW=150 kW water in 10° C. water out 90° C. flow 1648 L/h.

New flow rate 5.944 L/h.

Energy delivered: 50 KW+150 KW=200 KW, operating power 37.5 KW Overall COP 5.3.

Heat recovery Stage 1 225 KW, 10 kW to tank 5, water in 10° C., water out 20° C., flow 859 L/h, 117 kW source to heat pump 37.5 kWe required

Heat pump output 117 kW+35.5 kW=150 kW, water in 10° C., water out 90° C., flow 1648 L/h

New flow rate 2.507 L/h.

Energy delivered: 10 KW+50 KW=160 KW operating power 37.5 KW.

Overall COP 4.46.

It will be appreciated that the system delivers reliable temperature and flow to process with a variable flow demand, whilst maintaining the required temperatures. Also, it avoids the need for delivery-side heat exchangers and therefore avoids potential for fouling.

Also, it will be appreciated that the reduced temperature from the heat pump, being the temperature on to the turbine heat exchanger 6, allows additional heat to be extracted from the flue gas flow from the turbine, thus increasing the efficiency of Stage 3.

Advantageously, the system 1 is arranged so that the quality, or temperature, of the heat source is matched to the temperature requirement to optimise the efficiency of each stage.

The invention is not limited to the embodiments described but may be varied in construction and detail.

1-26. (canceled)

27. An energy system comprising:
a high temperature water heater and a high temperature storage tank arranged to deliver hot water on a high temperature line,
a heat pump and a low temperature storage tank arranged to deliver lower temperature water on a low temperature line,
a plurality of hot water supply circuits each arranged to:
receive high temperature water from the high temperature line,
receive low temperature water from the low temperature line, and
deliver a process water supply at a desired high, low, or intermediate temperature in an outlet line, in which a supply circuit delivering water at an intermediate temperature is arranged to blend the high temperature and low temperature flows; and
a controller configured to control the system.

28. The energy system as claimed in claim 27, wherein at least one supply circuit comprises a return.

29. The energy system as claimed in claim 27, wherein the system comprises a pump for delivering high temperature water to the supply circuits, and the controller is configured to control said pump according to sensed pressure between the pump and the supply circuits.

30. The energy system as claimed in claim 27, wherein the controller is configured to control the water heater and the blending in real time; and wherein at least one supply circuit comprises a low temperature line pump, and the controller is configured to control said pump according to sensed temperature in the supply circuit outlet line to achieve a desired level of blending.

31. The energy system as claimed in claim 27, wherein at least one supply circuit receives water only from the high temperature line; and wherein said at least one supply circuit comprises a temperature sensor in its outlet, and the controller is configured to control the high temperature water heater according to temperature sensed by said circuit.

32. The energy system as claimed in claim 27, wherein at least one supply circuit is arranged to deliver process water at the temperature of the low temperature line, and the controller controls a pump to dynamically control blending of water from the high temperature line, the low temperature line and a return line to provide process water.

33. The energy system as claimed in claim 27, wherein the high temperature water heater comprises the heat pump.

34. The energy system as claimed in claim 27, wherein the high temperature water heater comprises a gas turbine and a flue gas heat exchanger, said heat exchanger being arranged to heat water for delivery to the high temperature storage tank; and wherein the turbine is arranged to provide electrical energy for the heat pump, either directly or indirectly, with surplus generated electricity being provided for a process.

35. The energy system as claimed in claim 27, wherein the system comprises a heat recovery heat exchanger arranged to recover heat from external process equipment; and wherein the heat recovery heat exchanger is arranged to heat a cold water supply to a higher temperature level provided to the heat pump, so that the heat pump can operate at a lower compression ratio than if it received the cold water supply; and wherein the heat pump is arranged to feed back water to the heat recovery heat exchanger inlet.

36. The energy system as claimed in claim 27, wherein a controlled output temperature from the heat pump is adjustable downwards to increase coefficient of performance COP of the heat pump.

37. A method of operation of an energy system comprising:
a controller,
a water heater,
a high temperature water tank,
a high temperate water line,
a low temperature water tank,
a low temperature water line,
a heat pump,
a plurality of hot water supply circuits each having an outlet line,
the method comprising the steps of:
the high temperature water heater and the high temperature storage tank delivering hot water on the high temperature line,
the heat pump and the low temperature storage tank delivering lower temperature water on the low temperature line,
the hot water supply circuits:
receiving high temperature water from the high temperature line,
receiving low temperature water from the low temperature line, and
delivering a process water supply at a desired high, low, or intermediate temperature in the outlet line, in which at least one of said hot water supply circuits delivers water at an intermediate temperature by blending the high temperature and low temperature flows.

38. The method as claimed in claim 37, wherein the system comprises a pump in the high temperature line and the controller controls said pump according to sensed pressure between the pump and the supply circuits.

39. The method as claimed in claim 37, wherein the controller controls the water heater and the blending in real time.

40. The method as claimed in claim 37, wherein at least one supply circuit comprises a low temperature line pump, and the controller controls said pump according to sensed temperature in the supply circuit outlet line to achieve a desired level of blending.

41. The method as claimed in claim 37, wherein the controller controls a pump to dynamically control blending of water from the high temperature line, the low temperature line and a return line to provide process water.

42. The method as claimed in claim 37, wherein the heat pump is the high temperature water heater and it feeds heated water to the high temperature water tank.

43. The method as claimed in claim 37, wherein the high temperature water heater comprises a gas turbine and a flue gas heat exchanger and said heat exchanger heats water for delivery to the high temperature storage tank; and wherein the turbine provides electrical energy for the heat pump, either directly or indirectly, with surplus generated electricity being provided for a process.

44. The method as claimed in claim 37, wherein the system comprises a heat recovery heat exchanger which recovers heat from external process equipment to heat a cold water supply to a higher temperature level provided to the heat pump, so that the heat pump operates at a lower compression ratio than if it received the cold water supply.

45. The method as claimed in claim 37, wherein the system comprises a heat recovery heat exchanger which recovers heat from external process equipment to heat a cold water supply to a higher temperature level provided to the heat pump, so that the heat pump operates at a lower compression ratio than if it received the cold water supply; and wherein the heat pump feeds back water to the heat recovery heat exchanger inlet.

46. The method as claimed in claim 37, wherein a controlled output temperature from the heat pump is adjusted downwards to increase coefficient of performance COP of the heat pump.
